(19) United States
(12) Patent Application Publication
(10) Pub. No.: US 2026/0098419 A1
(43) Pub. Date: Apr. 9, 2026

(54) PASSIVE FLOOD BARRIER

(71) Applicant: PS Industries Incorporated, Grand Forks, ND (US)

(72) Inventors: Daniel Thomas Satrom, Arvilla, ND (US); Preston Scott Painter, Grand Forks, ND (US); Patrick John Warren, Grand Forks, ND (US); Peter Allen Letvin, Emerado, ND (US); Nathan Joel Ueland, Grand Forks, ND (US)

(21) Appl. No.: 19/352,905

(22) Filed: Oct. 8, 2025

Related U.S. Application Data
(60) Provisional application No. 63/704,858, filed on Oct. 8, 2024.

(51) Int. Cl. E04H 9/14; E06B 9/00; E06B 9/15; E06B 9/17; E06B 9/58; E06B 9/62

(52) U.S. Cl. CPC E04H 9/145; E06B 9/15; E06B 9/17076; E06B 9/581; E06B 9/62; E06B 2009/007; E06B 2009/1522; E06B 2009/588

(57) ABSTRACT

A passive flood barrier that self-deploys to prevent or limit the passage of flood water through an opening in a structure such as a ventilation shaft. The passive flood barrier device includes a buoyant volume extending across at least a portion of the structural opening. The buoyant volume is configured to float in response to flood water near the structural opening. A flexible flood barrier is coupled to the buoyant volume. The flexible flood barrier is deployable from the buoyant volume as the buoyant volume travels upward in response to flood water near the structural opening.

### CROSS-REFERENCE TO RELATED APPLICATION

This application claims the benefit of U.S. Provisional Application No. 63/704,858, filed Oct. 8, 2024, the contents of which are incorporated herein by reference.

### TECHNICAL FIELD

This disclosure relates to devices and systems that prevent flood water from entering an opening in a building, such as an opening for a ventilation system.

### BACKGROUND

Ventilation systems are used in buildings to circulate air through a system of fans, filters, ducts, shafts, etc. Such systems may be used in conjunction with heating and air conditioning systems to provide warm or cool air to rooms distributed throughout a building, for example.

Rising flood water in a building can occur in conjunction with extreme environmental events, or due to failures in fluid distribution systems in a building, etc. The damage caused by rising flood waters can be made worse if such flood water enters into a system such as a ventilation system via an opening used, for example, to circulate air in a building.

A need exists to provide devices and/or methods for preventing flood water in a building from entering openings in ventilation systems and the like.

### BRIEF SUMMARY

Discussed herein are embodiments of a passive flood barrier for preventing, limiting, and/or restricting flood water from entering into openings within a building, such as through ventilation ducts and into ventilation shafts, for example.

Some embodiments of this disclosure describe a passive flood barrier that functions to form a seal at an opening in a ventilation shaft. The flood barrier comprises passive elements that do not require power or operator intervention. A passive flood barrier according to some embodiments of this disclosure includes a buoyant drum and a flexible flood barrier coupled to the buoyant drum. The flexible flood barrier is configured to be rolled around the buoyant drum and disposed near a bottom portion of the opening to be protected. The buoyant drum and flexible flood barrier may be positioned generally horizontally across the bottom portion of the opening such that a rising water level from flooding will cause the buoyant drum to float and rise upward with the rising water level, unrolling and deploying the flexible flood barrier across the opening as the buoyant drum rises. A vertical track or guide may be disposed vertically on either side of the opening to keep the buoyant drum positioned near enough to the opening to help position the flexible flood barrier across the opening. As the buoyant drum rises, it unrolls the flexible flood barrier material, which is thereby positioned to form a seal against the frame or housing of the opening in the ventilation shaft. In some implementations, the flexible flood barrier material may be held against the frame or housing of the opening with the force of hydrostatic pressure from the flood water pushing against the flexible flood barrier.

In some embodiments, the flexible flood barrier may comprise a rubber material (e.g., a flexible rubber sheet, or a rubberized textile material) to help form a water-resistant seal at the opening. Other embodiments may employ other suitable materials that will float with and unroll from (and/or re-roll onto) the buoyant drum as it rotates and rises and/or lowers. In some embodiments, the flexible flood barrier may be made of a hinged or jointed configuration that allows it to coil and/or fold during deployment and/or retraction. The flexible flood barrier may be attached at or near the bottom portion of the opening to ensure good positioning or placement of the flexible flood barrier at its initial point of contact with the sealing surface of the housing of the opening. In some implementations, a gasket may be placed around a periphery of the opening to enhance the quality of the seal to be formed between the flexible flood barrier and the housing or enclosure surrounding the opening.

Other structural considerations may include configuring the flexible flood barrier to resist various types of loading including wind, hydrostatic, hydrodynamic, wave, and flood borne debris impact loading. A support structure can be implemented across the area of the building opening to support the flexible flood barrier. The support structure may be designed to resist the site-specific loads and often takes the form of grating to allow air to freely flow through the opening when ventilation is required. Aperture size in the grating is also a structural consideration and can be dependent on the structural capacity of the flexible flood barrier to span across specific aperture sizes without rupture. In other examples, the flexible flood barrier can have structural stiffener slats installed to increase the span of the structural grating or reduce the need to provide structural support across the opening when the barrier is in the stowed position. This enables the passive flood barrier to be utilized in building openings that have personnel or vehicle traffic, for example. In other implementations, the passive flood barrier can be installed around a door or window (or other such application with a backing structure). In such implementations, the flexible flood barrier can transfer flood load directly to the structure behind it, such as the door or window (or supporting frames associated therewith) if they are so equipped to support the load.

In some embodiments, the passive flood barrier may be configured to return to a rolled-up or “stowed” configuration to be ready for a subsequent flooding event. As the flood water level recedes, the buoyant drum will lower as well, and the flexible flood barrier will tend to roll back around the buoyant drum. Re-rolling or re-coiling of the flexible flood barrier around the buoyant drum may be facilitated or enhanced by a number of mechanisms. For example, the vertical tracks or guides that help the buoyant drum travel upward while maintaining a position and orientation relative to the opening may also function to guide the buoyant drum back downward, which may facilitate rolling of the flexible flood barrier around the buoyant drum. In certain implementations, the re-rolling of the flexible flood barrier around the buoyant drum may be enhanced via the use of a rack-and-pinion gear arrangement. For example, a circular gear may be disposed at one or both ends of the buoyant drum with gear teeth configured to engage and travel along corresponding gear teeth formed in one or both vertical tracks or guides. Another implementation for helping the flexible flood barrier re-roll when water levels recede may include the use of a constant force spring configured to provide tension on the buoyant drum and urge it downward to its normal “ready” position. Yet another implementation for helping the flexible flood barrier re-roll when water levels recede may include the use of a magnetic strip or magnetic tape disposed along a surface of the flexible flood barrier to create a force that may help to urge the buoyant drum and flood barrier to recoil to its normal “ready” position.

Some embodiments of this disclosure describe a passive flood barrier that functions to form a seal at an opening in a ventilation shaft or a comparable structural opening. The flood barrier comprises passive elements that do not require power or operator intervention. A passive flood barrier according to some embodiments of this disclosure includes a buoyant volume and a flexible flood barrier operably coupled to the buoyant volume. The flexible flood barrier is configured to be deployed by the buoyant volume; in normal (e.g., “dry”) conditions, the buoyant volume and flexible flood barrier are disposed near a bottom portion of the opening to be protected (e.g., the opening to be at least partially sealed or blocked by the flexible flood barrier to thereby prevent or minimize the flow of flood water through or past such opening). The buoyant volume and flexible flood barrier may be positioned generally horizontally across the bottom portion of the opening such that a rising water level from flooding, for example, will cause the buoyant volume to float and rise upward with the rising water level. The upward movement of the buoyant volume causes the flexible flood barrier to be deployed across the opening as the buoyant volume rises. A vertical track or guide may be disposed vertically on either side of the opening to keep the buoyant volume positioned near enough to the opening (e.g., near enough laterally) to help position the flexible flood barrier across the opening. As the buoyant volume rises, it causes the flexible flood barrier material to deploy (e.g., to extend from a bottom portion of the opening upward to a height determined by the rising of the buoyant volume). The flexible flood barrier material is thereby positioned to form a seal against the frame or housing of the structural opening. In some implementations, the flexible flood barrier material may be held or urged against the frame or housing of the opening with the aid of the force of hydrostatic pressure from the flood water pushing against the flexible flood barrier.

In some embodiments, the flexible flood barrier may be formed of a series of hingedly-coupled horizontal members. For example, the flexible flood barrier may comprise a plurality of elongate beams (e.g., hollow, rectangular aluminum members) pivotably or hingedly coupled to one another. Such an arrangement may form a barrier to fluid when the beams have been deployed or extended to form a “wall” or a generally flat surface. The pivotable or hinged connections between adjacent beams may facilitate deployment of the flexible flood barrier from a stored/stowed configuration to a deployed flood barrier configuration in response to rising flood levels, and may also facilitate subsequent stowage of the flexible flood barrier as flood levels recede and/or when the flood barrier is not needed. In some embodiments, the hingedly-coupled horizontal members of the flexible flood barrier may further comprise gaskets along and/or between adjoining edges that become compressed when the flexible flood barrier is in a deployed or extended configuration, for example. In some embodiments, a flexible flood barrier may be configured to be deployed from, and returned for storage into, the buoyant volume assembly to which it is operably coupled.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the scope of this disclosure. Accordingly, the drawings and detailed description are to be regarded as illustrative in nature and not restrictive.

### BRIEF DESCRIPTION OF DRAWINGS

FIG. 1A is a rear perspective view of an opening in an enclosure for a ventilation shaft or other structural opening according to some embodiments of this disclosure;

FIG. 1B is a front perspective view of an opening in an enclosure for a ventilation shaft (or other structural opening) with a passive flood barrier installed according to some embodiments of this disclosure;

FIG. 2A is a front perspective view of an opening in a ventilation shaft (or other structural opening) with a passive flood barrier in a fully deployed configuration, according to some embodiments of this disclosure;

FIG. 2B is a front perspective view of a passive flood barrier for an opening in a ventilation shaft (or other structural opening) in a fully deployed configuration, according to some embodiments of this disclosure;

FIG. 3 is an exploded view of exemplary elements of a passive flood barrier for an opening in a ventilation shaft (or other structural opening), according to some embodiments of this disclosure;

FIG. 4A is a perspective view of a flexible flood barrier of a passive flood barrier according to some embodiments of this disclosure;

FIG. 4B is a perspective view of a flexible flood barrier of a passive flood barrier with a series of stiffening members disposed therein, according to some embodiments of this disclosure;

FIG. 5A is an enlarged perspective view of an exemplary pinion gear that may be used with a passive flood barrier according to some embodiments of this disclosure;

FIG. 5B is an enlarged perspective view of an exemplary gear track that may be used in conjunction with the pinion gear of FIG. 5A according to some embodiments of this disclosure;

FIGS. 6A-6C are top perspective views of an embodiment of a passive flood barrier including a buoyant volume, a flexible flood barrier, and a coiling mechanism in varying phases of deployment according to some embodiments of this disclosure;

FIGS. 7A and 7B are enlarged perspective views of a portion of an assembly including a buoyant volume disposed below the coiling mechanism of a partially deployed passive flood barrier according to some embodiments of this disclosure;

FIGS. 8A-8C are side cross-sectional views of an exemplary flexible flood barrier according to some embodiments of this disclosure;

FIGS. 9A-9E are schematic cross-sectional views showing various exemplary configurations and arrangements of a passive flood barrier disposed within a structural opening according to some embodiments of this disclosure;

FIGS. 10A-10D are schematic side views of a passive flood barrier operating within a structural opening during various phases of flooding, according to some embodiments of this disclosure; and

FIG. 11 is a flow chart of a method of installing an exemplary passive flood barrier in an existing structure, such as a ventilation shaft (or other structural opening) according to some embodiments of this disclosure.

### DETAILED DESCRIPTION

This disclosure describes a flood barrier for flood wall openings, tunnels, building openings including wall openings, floor openings, vent shafts, doors, windows, and louvers. The flood barrier can be configured and sized to install in a variety of building infrastructure openings that need to be protected from flood waters. The flood barrier can be an automatically deploying (passive) system that does not require power or human action in order to be effective. The features of the passive flood barrier include a perimeter frame, a flexible flood barrier, a flexible flood barrier carrier, and a buoyant volume (or buoyant drum). In some embodiments, the flexible flood barrier carrier and the buoyant volume may be the same structure and may be collectively referred to herein as the buoyant volume or buoyant volume assembly.

The flexible flood barrier and buoyant drum (or buoyant volume) of the passive flood barrier is normally (e.g., in dry, non-flood conditions) positioned in a lower portion of the frame or housing adjacent an opening in the frame. As flood waters rise and begin to partially submerge the buoyant volume, the buoyant volume and the flexible flood barrier carrier begin to float near the surface of the flood water. Moving upwardly, the flexible flood barrier is deployed from the flexible flood barrier carrier to a position adjacent to the sealing surface of the perimeter frame. Hydrostatic pressure from the rising flood water may act on the deployed flexible flood barrier and generate a pressure between the flexible flood barrier and the frame, which may help to create a relatively watertight seal. In some embodiments, the flexible flood barrier may have sufficient contact with a perimeter frame that hydrostatic pressure is not required to form a seal. In some examples, a rubberized gasket can be installed to the perimeter frame (e.g., around the opening) or on the flexible flood barrier perimeter to enhance the watertight seal between the perimeter frame and the flexible flood barrier. To further create a sealing surface force between the flexible flood barrier and the perimeter frame, the flexible flood barrier may include stiffness members, which can assist to transfer a larger area of hydrostatic pressure to a more localized sealing surface (such as a rubberized gasket) thus increasing the sealing surface compression force which enhances watertightness at the sealing surface. In some embodiments, one or more stiffening members may be attached to or embedded within the flexible flood barrier. The stiffening members may comprise thin, flat portions or “slats” disposed across a width of the flexible flood barrier and may help improve the quality of the seal against the opening. A plurality of slats may be used, each slat being arranged horizontally across a width of the flexible flood barrier and spaced apart vertically from adjacent slats so that they are deployed one after another as the flexible flood barrier unrolls with rising flood water levels. While the deployed portion of the flexible flood barrier is under water loading, it tends to remain in a relatively stable position (e.g., it is not sliding up or down the perimeter frame while it is deployed).

As flood waters recede near the opening, it is desirable for the flexible flood barrier to retract from the deployed position back to a position on the flexible flood barrier carrier. To aid in the retraction of the flexible flood barrier, a retraction mechanism can be utilized. With a retraction mechanism, the barrier is re-installed onto the flexible flood barrier carrier as the water level lowers, allowing the flexible flood barrier to be made ready for the next flood event. In some embodiments, the flexible flood barrier may require human intervention to fully retract and/or properly stow the flexible flood barrier after one or more flood events in order to be made ready for a subsequent event.

In certain embodiments, the flexible flood barrier carrier may be made of a round rotating drum around which the flexible flood barrier may be rolled or wound. In such embodiments, the retraction mechanism may instigate or initiate rotation of the drum so that the flexible flood barrier is wound or rolled back onto the carrier from the deployed position as the flood water level lowers. Rotational motion can be induced by various designs. In some examples, rotational movement can be induced by coupling the surface of the rotating flexible flood barrier carrier drum with a stationary surface of the side frame. In one example this could be accomplished by frictional forces between the coiled flexible flood barrier (or drum) and the side frame. In another example this can be accomplished by a rack and pinion system, where a pinion gear of a defined size is positioned on the flexible flood barrier carrier, and a mating rack gear is positioned statically near the side frame. In another example, rotation can be induced by manufacturing the flexible flood barrier to be predisposed to be coiled so that as the flexible flood barrier carrier lowers (with receding flood water levels), the flexible flood barrier wraps itself back around the carrier drum. Some examples of accomplishing this pre-dispositioned coiling is to utilize one or more constant force springs, or to have other parts of the flexible flood barrier formed with a coiled “memory,” such as through the use of shape memory materials. In yet another example, a spring mechanism (e.g., a torsion spring mechanism) coupled between the flexible flood barrier carrier drum and a non-rotational component could create a torsional moment within the flexible flood barrier carrier drum. In some instances, the flexible flood barrier may re-install itself on the flexible flood barrier carrier without any additional mechanism to induce rotation.

In some examples, the buoyant volume can be integrated into the flexible flood barrier carrier and it can be configured to rotate as flood waters rise and fall to allow the flexible flood barrier to rotate to uncoil (deploy) and coil (retract) the flexible flood barrier. In other uses, tilting the barrier to a non-vertical plane allows flood protection to building or infrastructure openings that are not arranged vertically, such as diagonal vent shafts or floor openings. For example, if the barrier is installed 45 degrees from a vertical plane, then the barrier could protect a floor opening that is 0.707 times the nominal overall height of the flood barrier. Multiple flood barriers could be installed in a floor opening to allow an unlimited dimensional floor opening.

In other examples, buoyant deployment of the barrier can be achieved by a buoyant volume that is separate or de-coupled from the flexible flood barrier carrier; for example, the buoyant volume and flexible flood barrier carrier may be linked together to enable barrier deployment in any direction (upward, diagonal, horizontal). In such embodiments, the buoyant volume need not be configured to rotate in order to cause deployment or unfurling of the flexible flood barrier. In some embodiments, the flexible flood barrier may be made of a number of aluminum slats hinged together, and may optionally include one or more gaskets positioned to help form a seal between such slats when deployed. In other embodiments, the flexible flood barrier could be made of a sheet of a relatively hard material, such as a plastic or thin metal, while still enabling coiling and/or stowing of the flexible flood barrier material when not deployed. It should be further noted that the flexible flood barrier carrier can be used to coil the barrier in some embodiments, while it may also be stowed in other alternative ways (e.g., it does not need to coil or store in a rotational way, rather, it could “z” fold upon itself or otherwise stow itself). In some exemplary embodiments, the buoyant volume would not rotate (and would not need to rotate) if it is not facilitating re-coiling of the flexible flood barrier.

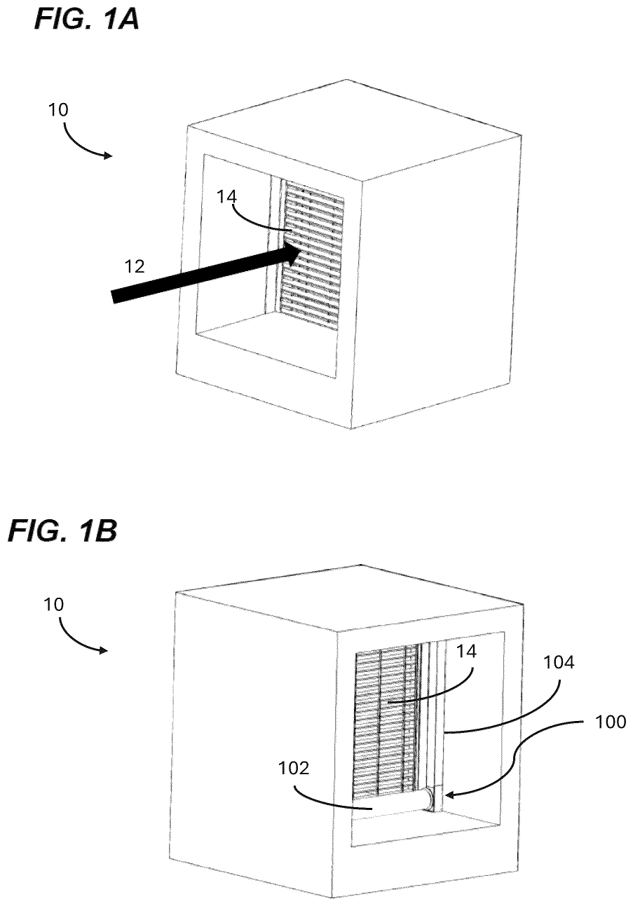

FIG. 1A is a rear perspective view of a structural opening 10 formed in an enclosure, frame, or housing of a ventilation shaft. The arrow 12 in FIG. 1A indicates one possible direction for air to flow through the opening, which may include a grate covering 14, as shown. It should be noted that the direction of air flow could be in either direction according to various embodiments.

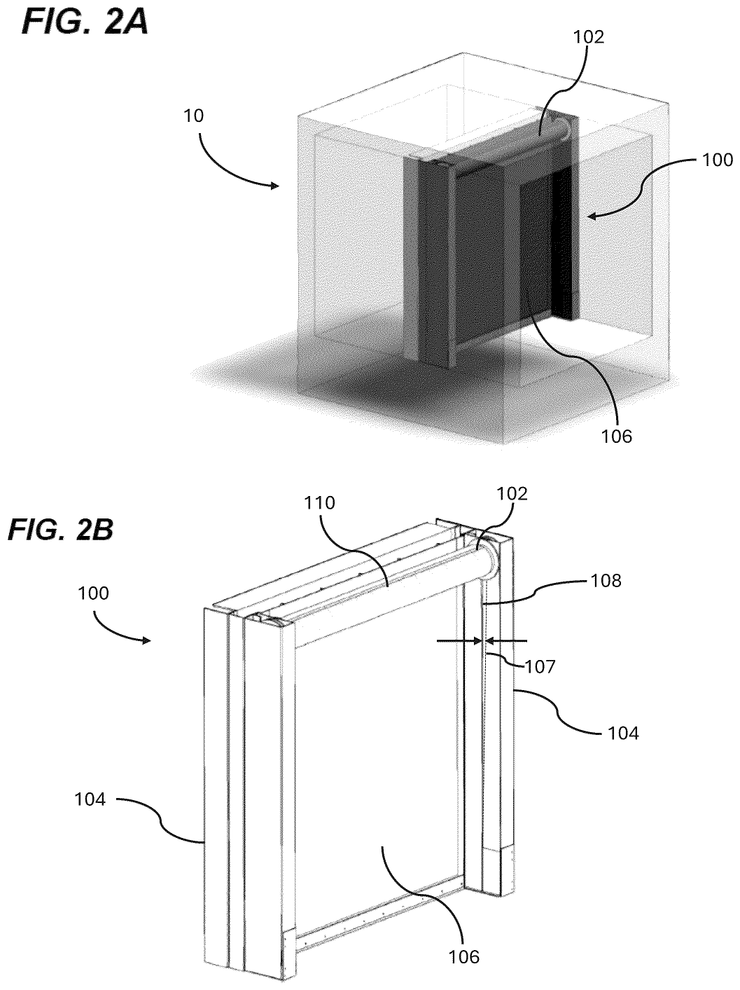

FIG. 1B is a front perspective view of structural opening 10 formed in an enclosure or housing of a ventilation shaft. The enclosure/housing and the structural opening 10 shown in FIG. 1B are depicted with a passive flood barrier device 100 installed according to some embodiments of this disclosure. The passive flood barrier 100 is shown in its normal or “dry” configuration disposed at its lowest position in the enclosure (e.g., to allow air to flow freely through the opening 10 during normal operations). As shown, a buoyant volume 102 is positioned across a width of the structural opening 10 along with a flexible flood barrier. In the particular embodiment shown, the buoyant volume 102 comprises a buoyant drum (e.g., a buoyant drum 110 as depicted in FIG. 2B, a generally cylindrical drum including a density of less than 1 gram per cubic centimeter (g/cm³) configured to float in water or other flood liquids) that is positioned across a width of the structural opening 10 along with the flexible flood barrier material in a wound or rolled up configuration around the buoyant drum 110. Also shown is a guide 104 disposed at one end of the drum and extending in a vertical direction to guide vertical travel of the buoyant volume 102 upward and downward along the face of the structural opening 10 (the other side of the buoyant volume 102, and a counterpart vertical track or guide is obscured from view in FIG. 1B).

Installation of the housing (or frame, or enclosure) of the passive flood barrier 100 can be onto a face of a building or into a tunnel shaft of various configurations such as a ventilation shaft. Perimeter frame modifications may be made to allow the flood barrier to be adaptable to various installation wall and floor shapes, for example. In some circumstances the flood barrier can be configured to adapt to non-rectangular openings by modification of the frame or of the shape of the flexible flood barrier. In some implementations, the flood barrier may be installed so that the flexible flood barrier and carrier/drum are positioned below ground level with the remainder of the building opening above ground level to permit foot or vehicle traffic over the top and through the opening in non-flooding scenarios.

FIG. 2A is a front perspective view of structural opening 10 in a ventilation shaft with an exemplary passive flood barrier 100 installed. The passive flood barrier 100 is shown with the buoyant volume 102 and flexible flood barrier 106 in a fully deployed configuration (e.g., as it would appear in response to a flooded condition). The buoyant volume 102 has floated to an upper position within the enclosure due to rising fluid levels (e.g., rising flood water levels) at the external side of the opening 10, and the flexible flood barrier 106 has been deployed (e.g., extended from a lower position within the enclosure to an upper position within the enclosure by upward movement of the buoyant volume 102).

FIG. 2B is an enlarged perspective view of the passive flood barrier 100, showing additional details of the vertical tracks or guides 104 disposed at either end of the buoyant drum 110. FIG. 2B shows a flexible flood barrier 106 that has deployed (e.g., it has unrolled) from its rolled configuration around the buoyant volume 102 (e.g., the stowed configuration) and has been positioned to cover the structural opening and form a seal or barrier to at least limit the flow of flood liquid (e.g., water) past the opening and into the ventilation shaft. In some embodiments, the buoyant volume 102 includes the buoyant drum 110 and/or a member disposed along the axis of the buoyant drum 110 and configured to slide within a slot 108 formed in the vertical tracks or guides 104. A slot 108 can be formed in one or both sets of vertical guides 104 to keep the buoyant drum 110 (and hence, the flexible flood barrier 106 coupled thereto) aligned relative to the structural opening during vertical (upward and/or downward) travel of the buoyant drum 110. It may be desirable in some embodiments for the slot 108 to form a slight angle 107 relative to the vertical guides (e.g., a slight angle from vertical) such that the slot becomes somewhat closer to the structural opening at an upper end than at a lower end of the slot. Such an embodiment may, for example, help account for a reduction in diameter of the rolled flexible flood barrier material of the flexible flood barrier 106 as it unrolls from the buoyant drum 110 during upward travel thereof. That is, when at its upper position, the outer diameter of the buoyant drum 110 and the flexible flood barrier material will be smaller than when at its lower positions; a slight angle in the slot (or slots) may help compensate for the changing diameter in order to maintain a good sealing relationship between the flexible flood barrier 106 and the housing around the opening throughout the vertical travel of the buoyant drum 110.

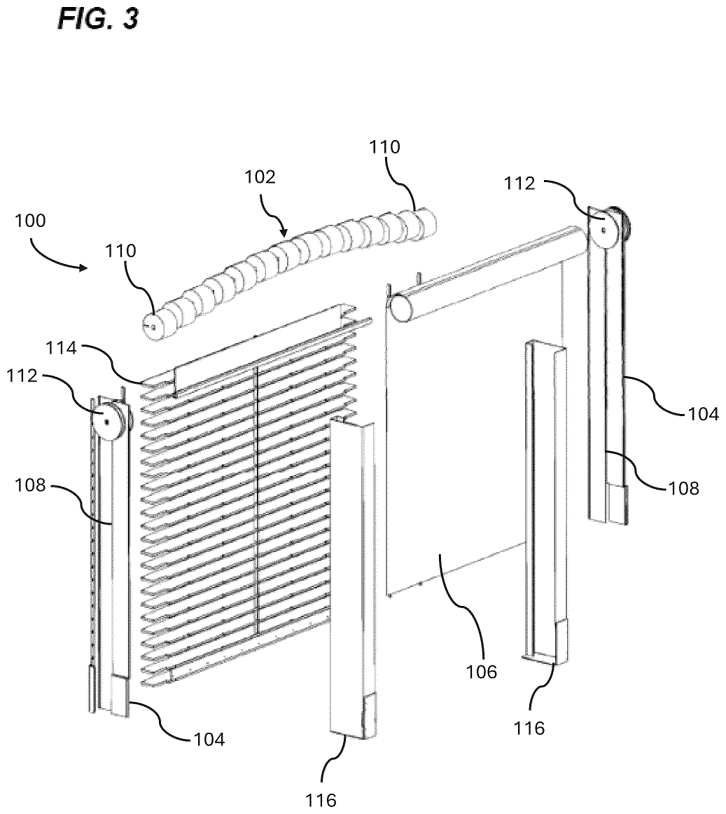

FIG. 3 is an exploded view of a number of exemplary elements of a passive flood barrier 100, according to some embodiments of this disclosure. For example, the embodiment of FIG. 3 depicts the buoyant volume 102 as comprising a plurality of buoyant drums 110 placed end-to-end. In some embodiments, the buoyant drum 110 (whether a single elongate drum, or whether formed of a plurality of smaller drums) may be formed with a square cut-out to receive a square-shaped center hub (not shown in FIG. 3); such a shaped configuration may help ensure that all portions of the buoyant drum are “keyed” to rotate synchronously. Shapes other than square could be employed to accomplish this purpose as well (e.g., hexagonal, octagonal, etc.). FIG. 3 also shows an exemplary arrangement of guide spools or gears 112 disposed at either end of buoyant drum 110. The guide spools or gears 112 are configured to have a narrow axial portion disposed between two discs, the narrow axial portion configured to ride in the slot 108 (or slots) formed in the inner portion of the vertical guides/tracks 104. The guide spools or gears 112 can engage with tracks 116. The guide 104 can include a first track 116 positioned at a first side of the structural opening and a second track 116 positioned at a second side of the structural opening and the buoyant volume can include a first spool 112 to travel along the first track 116 and a second spool 112 to travel along the second track 116 to maintain a generally horizontal orientation of the buoyant volume 102. In some embodiments, the flexible flood barrier 106 can be deployed adjacent to a grate covering 114 to provide support for the flexible flood barrier 106 (e.g., when deployed and/or while deploying). The grate covering 114 can be installed within the guides 104 and/or the tracks 116, and/or the grate covering 114 can be installed within structural opening 10 (e.g., the grate covering 14 shown in FIG. 1A). The positioning of structural grating across the opening, for example, may provide support for the flexible flood barrier 106 when at least partially deployed, while maintaining air flow across the opening to the extent practicable.

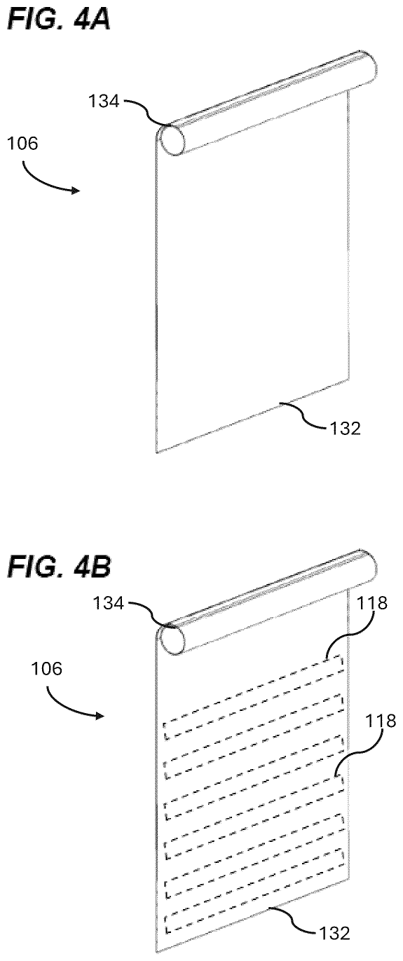

FIG. 4A is an upper perspective view of a flexible flood barrier 106 in a fully deployed (e.g., fully unrolled) configuration as it may appear when flood water levels rise enough to substantially cover the opening. A first end 134 of the flexible flood barrier 106 can be coupled to the buoyant volume 102 (e.g., the buoyant drum 110 of the buoyant volume 102) and a second end 132 of the flexible flood barrier 106 can be coupled to the structural opening (e.g., to the bottom surface of the structural opening 10 and/or to a frame feature positioned adjacent the bottom surface of the structural opening 10). Upward travel of the buoyant volume 102 in response to the flood water near the structural opening can increase a vertical distance between the second end 132 of the flexible flood barrier 106 and the buoyant volume 102.

FIG. 4B is an optional embodiment of a flexible flood barrier 106 having a series of stiffening members 118 or slats disposed across a surface of the flexible flood barrier. For example, the stiffening members 118 may comprise a thin, lightweight, flat material that is stiffer than the material of the flexible flood barrier. The stiffening members 118 may be attached to, or embedded within, the material of the flexible flood barrier 106. In use, the slats 118 may facilitate forming a higher quality seal at the opening. As shown, the stiffening members 118 are disposed in a generally horizontal orientation across the width of the flexible flood barrier material. As also shown, the stiffening members 118 may be spaced apart vertically along the height of the flexible flood barrier material. In use, such an arrangement of stiffening members 118 may result in sequential deployment of the slats as the flood level rises, according to some embodiments.

The stiffening members 118 may be formed of various materials. In some examples, one or more slats may be formed of aluminum and adhered to the flexible flood barrier. PVC (and/or other plastic-like materials) may also be used to form the stiffening members 118 for use with the flexible flood barrier. In some examples, the stiffening members 118 can be slid into pockets sewn into and out of the material of the flexible flood barrier. In some cases, the stiffening members 118 can extend across the width of the flexible flood barrier (or some portion of the width); in other cases, slats may be disposed/installed toward the outer side portions of the flexible flood barrier (e.g., roughly six inches or so from the side edges).

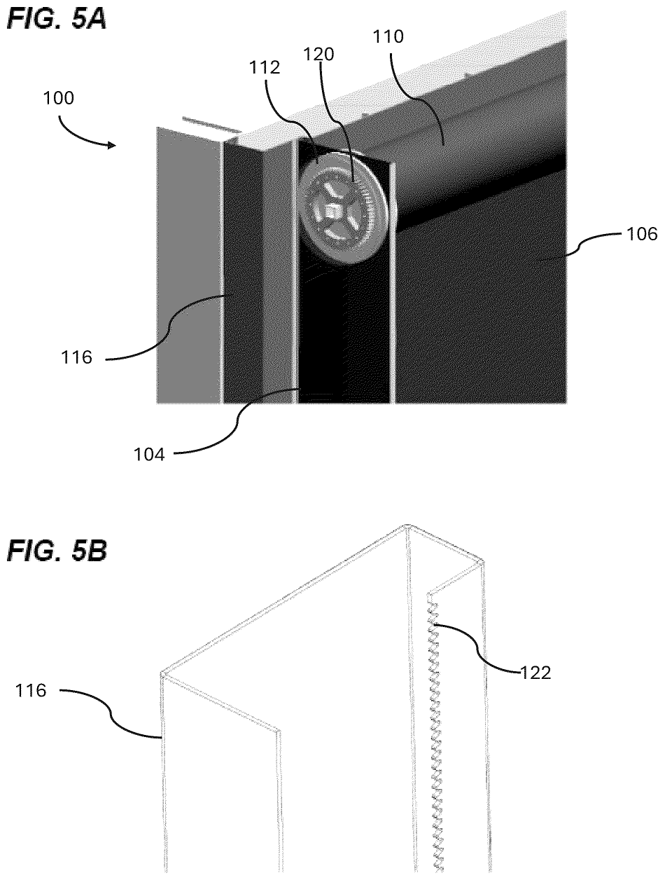

FIG. 5A is an enlarged perspective view of an exemplary pinion gear 120 that may be used with a passive flood barrier 100 according to some embodiments of this disclosure. The pinion-type gear 120 is shown disposed at one end of the buoyant drum 110. The pinion gear 120 can be positioned on and/or integrated with the guide spool or gear 112 described above. The pinion gear 120 is generally circular and has a plurality of gear teeth designed to engage with corresponding gear teeth of a gear track formed, for example, in one or both vertical tracks 116.

FIG. 5B is an enlarged perspective view of an exemplary track 116 that may be used in conjunction with the pinion gear 120 of FIG. 5A, according to some embodiments of this disclosure. A plurality of rack teeth 122 of the gear track 116 (e.g., the rack) in FIG. 5B corresponds to the gear teeth of the pinion gear 120 of FIG. 5A such that a defined amount of vertical travel of the buoyant drum relative to the vertical guides corresponds to a defined amount of rotation of the buoyant drum 110 about its longitudinal axis. As such, the use of such a rack-and-pinion gear arrangement may help facilitate the re-rolling of the flexible flood barrier 106 around the buoyant drum 110 when flood waters recede and the buoyant drum 110 begins to travel downward with the receding water levels, as the vertical travel of the guide spool 112 along the gear track imparts rotational motion to the buoyant drum 110. Other methods of re-rolling (or re-coiling) the flexible flood barrier 106 around the buoyant drum 110 may include (optionally or alternatively) the use of a constant force spring coupled to the buoyant drum and configured to apply some amount of torque on the buoyant drum 110 in a direction that places tension on the flexible flood barrier 106, which may thereby keep the flexible flood barrier 106 wound tightly (or without slack) around the buoyant drum 110. Another optional (or alternative) method of facilitating or enhancing the re-rolling of the flexible flood barrier 106 is via the use of one or more sections of magnetic tape (e.g., dual-sided magnetic tape) disposed along a length of the flexible flood barrier 106 to thereby create a force that may facilitate rolling of the flexible flood barrier 106 around the buoyant drum 110 during downward travel thereof, for example. In some implementations, a counterweight may be used with a cable wound around the buoyant drum 110 opposite the direction of the flexible flood barrier 106. The cable drum size may, for example, differ in diameter from that of the flexible flood barrier carrier to allow the counterweight to require less travel than the flexible flood barrier carrier. In some implementations, the flexible flood barrier 106 carrier may be pushed into a track and configured to recoil. In some embodiments, the flexible flood barrier 106 could z-fold, or randomly fold, into a storage volume. Other possible mechanisms may become apparent to those of ordinary skill in the art with the benefit of these teachings.

It should be noted that the passive flood barrier 100 of this disclosure has been thus far described with reference to a substantially vertical opening in an exemplary ventilation shaft. However, this disclosure is not so limited. For example, the present teachings could be applied with beneficial effect to a horizontally disposed opening (e.g., typically a floor mounted opening). In such an embodiment, a ramp-type arrangement is contemplated whereby a rising flood water level would cause flotation of a buoyant drum along an inclined ramp. Thus, the buoyant drum could be configured to travel both horizontally and vertically. The horizontal displacement of the buoyant drum could accordingly be coupled to horizontal placement of a corresponding flexible flood barrier across the horizontally disposed opening and thereby provide a flood barrier seal, in a manner similar to that provided in the accompanying drawings and described herein.

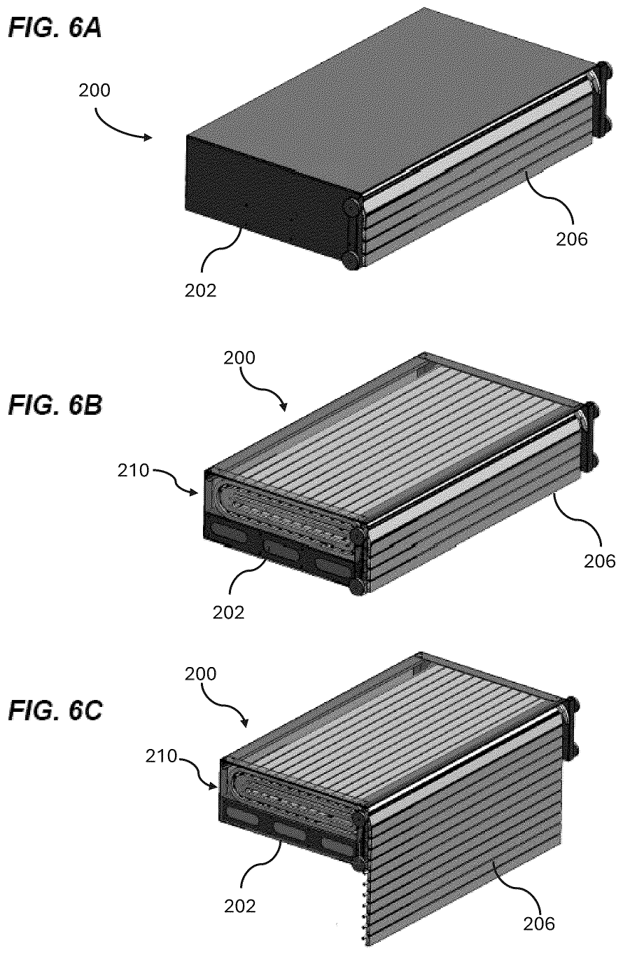

FIGS. 6A-6C are top perspective views of an embodiment of a passive flood barrier 200 including a buoyant volume 202 and a flexible flood barrier 206 operably coupled to the buoyant volume 202, shown in varying phases of deployment according to some embodiments of this disclosure. The passive flood barrier 200 can include any and/or all features of the passive flood barrier 100 described above with respect to FIGS. 1A through 5B, as applicable. FIG. 6A shows an exemplary buoyant volume 202 in accordance with some embodiments of this disclosure. The buoyant volume 202 shown is a generally rectangular-shaped box configured to house or store the flexible flood barrier 206 within a flexible flood barrier carrier portion of it, and to deploy the flexible flood barrier 206 from the buoyant volume 202 in response to rising flood levels.

FIG. 6B shows the buoyant volume 202 with the outer housing portion rendered in a transparent manner to show the placement of other elements. Inside the buoyant volume 202, the flexible flood barrier 206 can be seen as it might be stored within the buoyant volume 202, according to one implementation. For example, in this particular embodiment, the flexible flood barrier 206 is shown stored in a folded or back-and-forth arrangement across a width of the buoyant volume 202, with a generally coiled or spiral arrangement. Additionally, the flexible flood barrier 206 in this particular buoyant volume 202 embodiment is shown disposed in an upper portion of the buoyant volume 202 when stored therewithin (e.g., within a flexible flood barrier carrier 210); this arrangement may have possible advantages. For example, a lower portion of the buoyant volume 202 may be maintained relatively light weight by not housing the flexible flood barrier 206 in the lower portion. The flexible flood barrier 206, when deployed from such an arrangement, deploys or exits from the buoyant volume 202 from a higher position, which can help ensure that the deployed portion of the flexible flood barrier 206 extends sufficiently to form an adequate barrier to rising flood water levels. For example, the flexible flood barrier 206 exits the buoyant volume 202 and begins to descend downwardly some distance before it fully straightens to form a seal at the opening. By having the exit point positioned somewhat higher relative to the buoyant volume 202 (e.g., by storing the flexible flood barrier in an upper portion of the buoyant volume), the flexible flood barrier 206 may be better able to straighten and form a seal against adjacent portions of the opening, for example.

FIG. 6C shows a portion of the flexible flood barrier 206 descending downwardly from the buoyant volume 202 as it would in a partial flooding condition (e.g., the water level has risen but not enough to cover the entire structural opening).

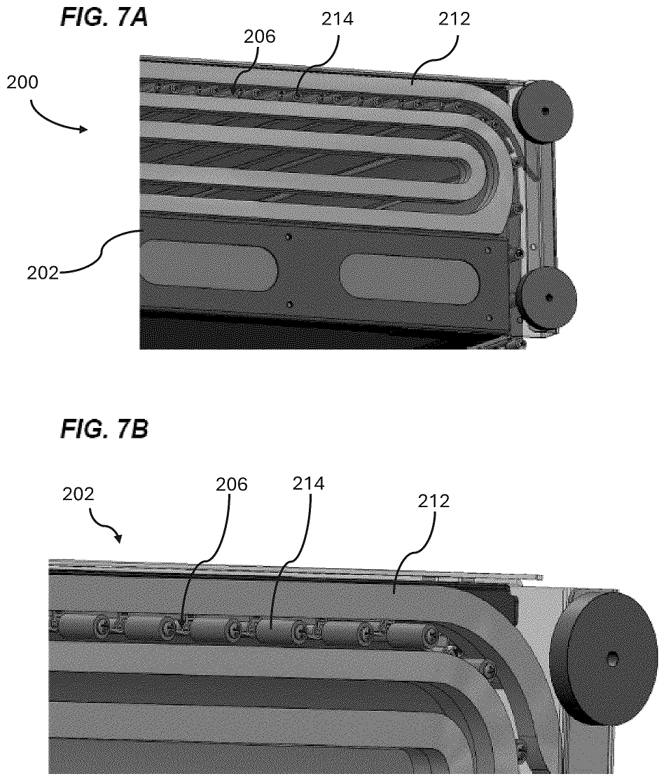

FIGS. 7A and 7B are enlarged perspective views of a portion of a buoyant volume 202 of a passive flood barrier device 200 according to some embodiments of this disclosure. FIG. 7A shows a portion of an exemplary buoyant volume 202. It shows one possible way of routing the flexible flood barrier 206 within the buoyant volume 202. The buoyant volume 202 includes a flood barrier track 212 that directs the flexible flood barrier 206 to coil or spiral in a generally inward direction, while having generally flat top, bottom, and/or side surfaces corresponding to the generally rectangular cross-sectional shape of this particular buoyant volume 202.

Alternatively, the flexible flood barrier 206 could be configured to fold into the buoyant volume 202 in a zig-zag pattern, for example from top to bottom, or from bottom to top, etc. FIG. 7B is enlarged to show rollers 214 that may be coupled to the side edges of the flexible flood barrier 206 to facilitate deploying and retracting the flexible flood barrier 206 from and to the buoyant volume 202.

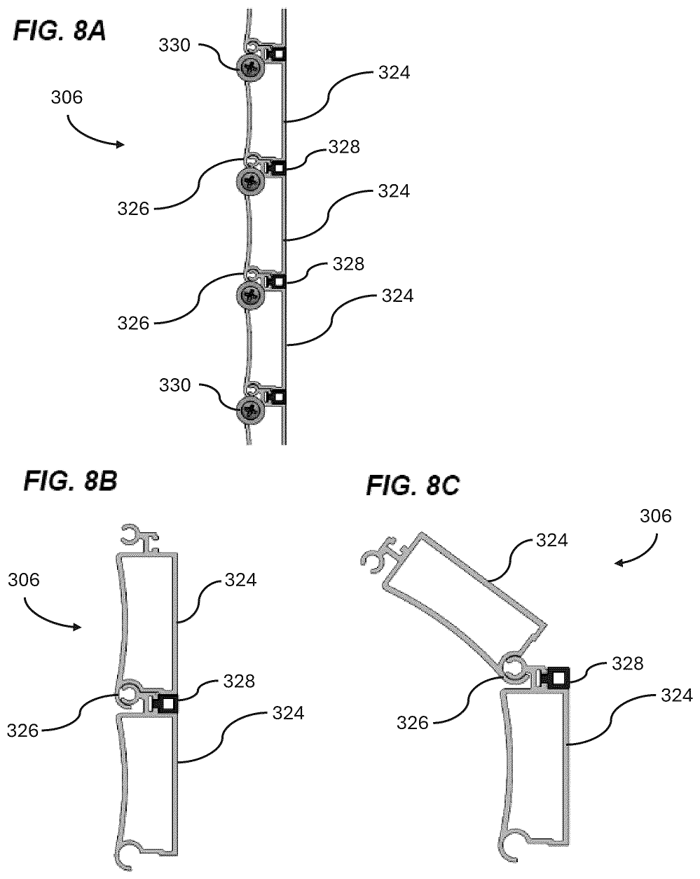

FIGS. 8A-8C are side cross-sectional views of an exemplary flexible flood barrier 306 according to some embodiments of this disclosure. FIG. 8A shows a side cross-sectional view of an exemplary flexible flood barrier 306 that can be used with the buoyant volume 202 shown in FIGS. 6A-7B. The flexible flood barrier 306 shown in FIG. 8A may be formed of a series of hingedly-coupled horizontal members 324. For example, the flexible flood barrier 306 can comprise a plurality of elongate beams (e.g., hollow, rectangular aluminum members) pivotably coupled via a hinge 326 to one another. Such an arrangement may form a barrier to fluid when the horizontal members 324 have been deployed or extended to form a “wall” or a generally flat surface. The pivotable or hinged connections between adjacent horizontal members 324 can facilitate deployment of the flexible flood barrier 306 from a stored/stowed configuration to a deployed flood barrier configuration in response to rising flood levels, and may also facilitate subsequent stowage of the flexible flood barrier 306 as flood levels recede and/or when the flood barrier is not needed. In some embodiments, the hingedly-coupled horizontal members 324 of the flexible flood barrier 306 may further comprise a plurality of gaskets 328 along and/or between adjoining edges that can become compressed when the flexible flood barrier 306 is in a deployed or extended configuration, for example. In some embodiments, a flexible flood barrier 306 may be configured to be deployed from, and returned for storage into, the buoyant volume 202 to which it is operably coupled.

FIG. 8B is an enlarged side cross-sectional view of a portion of the flexible flood barrier 306 showing a number of components that may be used to enable pivotable coupling of the horizontal members 324 to each other via one or more hinges 326. Also shown is a gasket 328 disposed between adjacent horizontal members 324 to help form a flood barrier or seal at the water-sealing surface of the flexible flood barrier 306.

FIG. 8C is an enlarged side cross-sectional view of the portion of the flexible flood barrier 306 of FIG. 8B, showing two adjacent horizontal members 324 that have hinged or pivoted via a pivotable coupling or joint or hinge 326, to form an angle relative to each other. Such an angle may be formed, for example, at a point where the flexible flood barrier 306 is deployed from the buoyant volume 202 and changes from a generally horizontal orientation to a generally vertical orientation. FIG. 8C shows certain details that may enhance the functionality of the flexible flood barrier 306. For example, the placement of the gasket 328 on one horizontal member 324 may facilitate forming a seal with an adjacent horizontal member 324 during deployment. In the exemplary embodiment shown in FIG. 8C, a gasket 328 is disposed along an uppermost, outer frame-sealing side (e.g., dry side) of a first horizontal member 324 such that a lower portion of an adjacent second horizontal member 324 above the first horizontal member 324 is configured to pivot into a compressive engagement with the gasket 328 of the first horizontal member 324 as the horizontal members 324 are straightened into a generally vertical, deployed configuration. One such arrangement is illustrated in FIGS. 8A-8C, but other similar arrangements could be devised by those of ordinary skill in the art with the benefit of these teachings. FIG. 8A illustrates the use of rollers 330 that may be employed at or near the pivotable joints 326 formed between horizontal members 324 of the flexible flood barrier 306; for example, rollers 330 disposed at either lateral end of the flexible flood barrier 306 may facilitate the deployment from, and subsequent retraction and storage into, the flexible flood barrier 306, according to various embodiments (e.g., via interaction with the flood barrier track 212 in FIGS. 7A-7B).

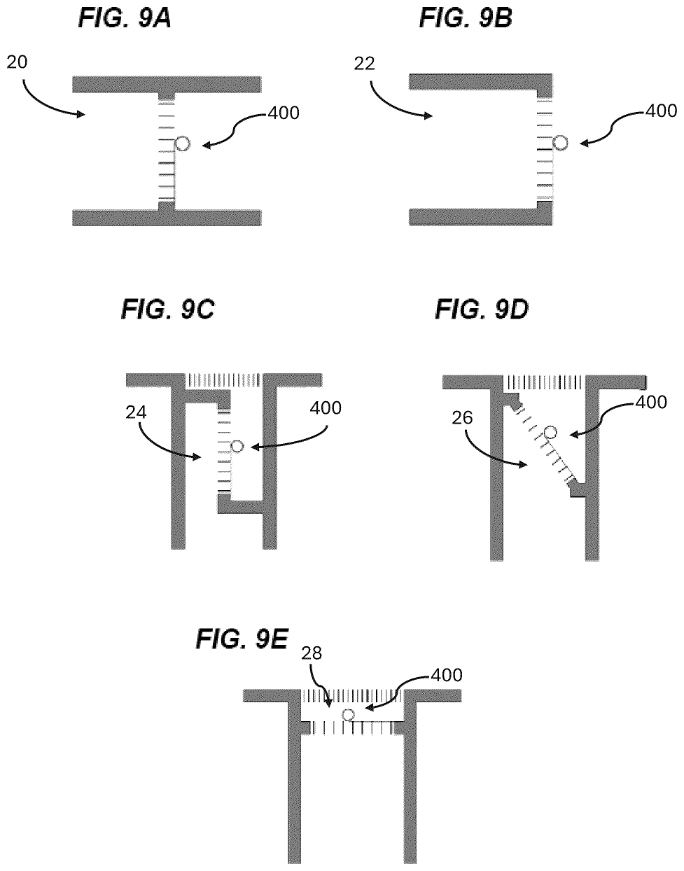

FIGS. 9A-9E are schematic cross-sectional views showing various exemplary configurations and arrangements of a passive flood barrier arrangement 400 disposed within a structural opening according to some embodiments of this disclosure. The passive flood barrier 400 can include any and/or all features of the passive flood barrier 100, 200 described above. FIGS. 9A and 9B show the placement of a passive flood barrier of this disclosure positioned to prevent flood water from flowing through an opening in a generally horizontal passage 20, 22, such as a ventilation shaft or duct. In FIG. 9A, for example, the passive flood barrier 400 is positioned to protect a structural opening 20 disposed in an intermediate location in a length of a horizontal passage. In FIG. 9B, for example, the passive flood barrier 400 is positioned to protect a structural opening 22 disposed at one end of a horizontal passage.

FIG. 9C shows an alternative arrangement of a passive flood barrier 400 according to this disclosure. In FIG. 9C, a first opening in a floor may allow flood water to drain down into the structure below, which includes a second opening 24 that generally resembles the configuration shown in FIG. 9A. As the flood water level near the second opening 24 rises, the buoyant volume of the passive flood barrier 400 rises to deploy a flexible flood barrier to block the second opening and thereby prevent flood waters from flowing freely down into spaces below the second opening (e.g., toward machinery, electronic equipment, fans, etc.).

FIG. 9D is a variation on the arrangement shown in FIG. 9C. FIG. 9D shows a passive flood barrier 400 according to this disclosure in which a first opening in a floor may allow flood water to drain down into the structure below. However, in this embodiment, a second opening 26 in the lower structure is disposed at an angle, as shown in FIG. 9D. As the flood water flows down through the first opening, the water level on one side of the second opening 26 (e.g., the right side, as depicted in FIG. 9D) rises, and the buoyant volume begins to rise to deploy the flexible flood barrier. With the angle formed, the buoyant volume of the passive flood barrier 400 will tend to both rise and move laterally (e.g., to the left in FIG. 9D) to place the flexible flood barrier across the angled second opening 26 and thereby prevent flood waters from flowing freely down into spaces below the second opening.

FIG. 9E shows yet another alternative arrangement of a passive flood barrier 400 according to this disclosure. In FIG. 9E, a first opening in a floor may allow flood water to drain down into the structure below, which includes a second opening 28 that is disposed in a generally horizontal configuration as shown. FIG. 9E shows a flexible flood barrier 400 configured to move generally horizontally or laterally across the second opening in response to flood waters entering the top or bottom of the vertical shaft. Entering flood waters can be routed to the buoyant volume of the passive flood barrier 400 and tend to urge a buoyant volume upward, while movement of the flexible flood barrier can be induced laterally by coupling the buoyant volume to the flexible barrier carrier by means of a linkage, cable and pulley, or other suitable mechanism. The embodiment of FIG. 9E may have a possible advantage in that it may be simple and/or convenient to install in or near existing floor openings, and in shafts with limited vertical height, for example.

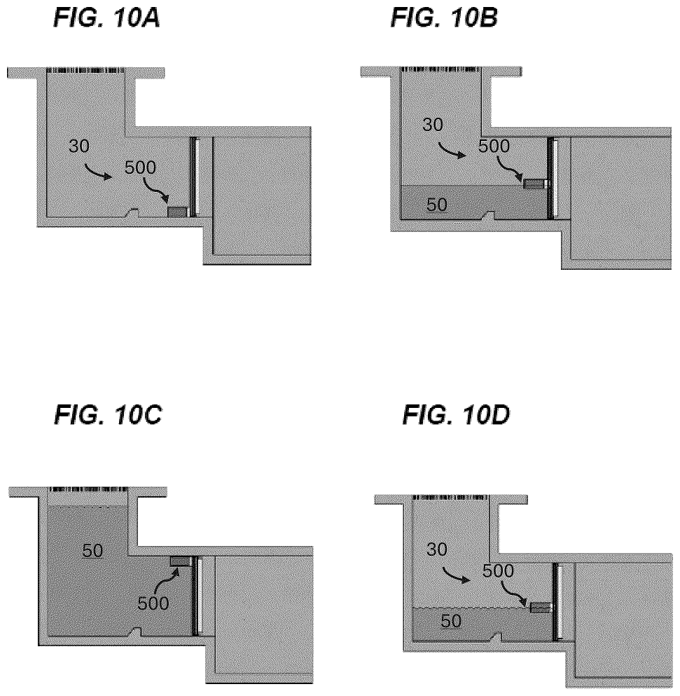

FIGS. 10A-10D are schematic side views of a passive flood barrier 500 operating within a structural opening 30 during various phases of flooding, according to some embodiments of this disclosure. The passive flood barrier 500 can include any and/or all features of the passive flood barriers 100, 200, 400 described above. FIG. 10A illustrates a passive flood barrier 500 installed in a configuration to protect flood water from draining through a floor opening and flowing past a second opening 30 in a structural path (such as a ventilation shaft or duct). FIG. 10A shows elements of the passive flood barrier 500 as they may be disposed during normal “dry” conditions.

In FIG. 10B, flood water 50 has fallen through the first opening (the floor opening) and has started to accumulate on the flood water side of the second opening 30. The rising flood level has resulted in the buoyant volume of the passive flood barrier 500 rising a portion of the way across the second opening and deploying the associated flexible flood barrier to partially cover the second opening (e.g., the passive flood barrier 500 in a partially deployed configuration). Maintaining the second opening 30 in a partially covered configuration may have an advantage of maintaining at least some amount of air flow through the second opening 30 as long as possible during a flooding event, according to some embodiments.

FIG. 10C shows the passive flood barrier 500 in a fully deployed configuration. Water 50 on the flood water side of the second opening continues to rise, while the passive flood barrier 500 system has prevented (or significantly restricted) water from flowing to the “protected” side of the second opening 30.

In FIG. 10D, the flood level has receded (and/or has been pumped away) such that the buoyant volume of the passive flood barrier 500 has dropped back to a level part-way up the second opening 30, and the associated flexible flood barrier coupled to the buoyant volume has partially retracted (e.g., back inside the buoyant volume in some embodiments). Returning the second opening 30 to a partially covered configuration (e.g., the passive flood barrier 500 in a partially deployed configuration) can have an advantage of restoring at least some amount of air flow through the second opening 30 as soon as possible following a flooding event, according to some embodiments.

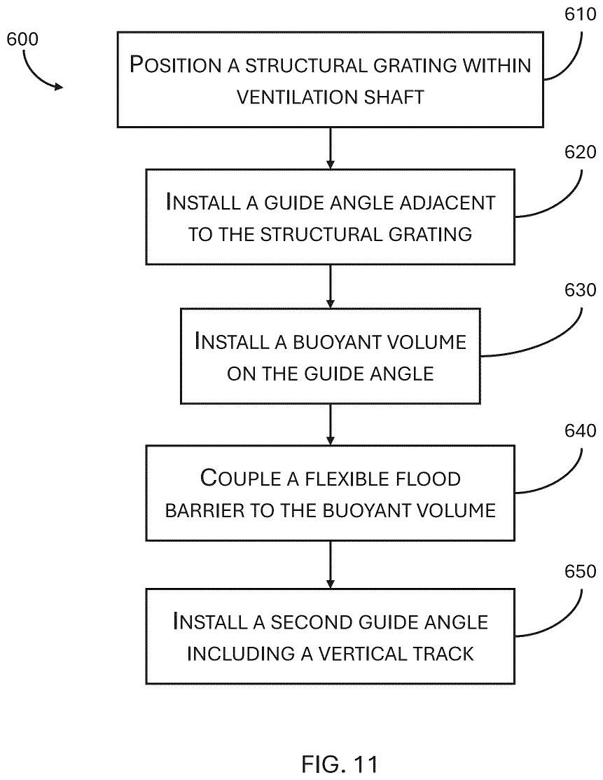

FIG. 11 is a flow chart of a method 600 of installing an exemplary passive flood barrier in an existing structure, such as a ventilation shaft, is described below. The method 600 can include any of the features of the passive flood barriers 100, 200, 400, 500 described above. The method 600 can include placement and installation of angle frames into a portion of the ventilation shaft at the location of the opening to be protected. At step 610, the method 600 can include positioning of structural grating and/or a gasket that may be employed according to certain embodiments of this disclosure. In some examples, the structural grating can already be installed into the ventilation shaft. At step 620, the method 600 can include installation of a first set of guide angles to be used for supporting and/or guiding the movement of the shuttle or buoyant volume, upward and downward relative to the opening. At step 630, the method 600 can include installation of the buoyant volume (or shuttle) relative to the associated guide angles and/or the connection of the flexible flood barrier near the bottom portion of the opening. At step 640, the method 600 can include operably coupling a flexible flood barrier to the buoyant volume and configured to be deployed therefrom. At step 650, the method 600 can include installation of a second set of guide angles; for example, the first and second sets of guide angles may form a vertical track within which rollers (or other comparable movable mechanisms) may be retained and guided during upward and downward movement of the buoyant volume. In some embodiments, rollers may extend laterally outward from both sides of the buoyant volume and ride up and down a channel formed by the first and second sets of guide angles

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A passive flood barrier device for a structural opening, the passive flood barrier device comprising:
a buoyant volume extending across at least a portion of the structural opening, the buoyant volume configured to float in response to flood water near the structural opening; and
a flexible flood barrier coupled to the buoyant volume and deployable from the buoyant volume as the buoyant volume travels upward in response to the flood water near the structural opening.

2. The passive flood barrier device of claim 1, wherein the flexible flood barrier includes a first end coupled to the buoyant volume and a second end coupled to the structural opening, wherein upward travel of the buoyant volume in response to the flood water near the structural opening increases a vertical distance between the second end of the flexible flood barrier and the buoyant volume.

3. The passive flood barrier device of claim 1, wherein deployment of the flexible flood barrier from the buoyant volume in response to the flood water is a passive deployment.

4. The passive flood barrier device of claim 1, wherein the structural opening comprises a sealing frame having a bottom portion, a first side, and a second side.

5. The passive flood barrier device of claim 1, further comprising:
a guide extending in a vertical direction across at least a portion of the structural opening, the guide operably coupled with the buoyant volume to guide travel of the buoyant volume in the vertical direction to position the flexible flood barrier to form a seal against the structural opening.

6. The passive flood barrier device of claim 3, wherein the flexible flood barrier is configured to be passively retracted as the buoyant volume travels downward in response to a receding flood water.

7. The passive flood barrier device of claim 6, wherein passive retraction of the flexible flood barrier is assisted by a retraction mechanism.

8. The passive flood barrier device of claim 5, wherein the guide includes a first track positioned at a first side of the structural opening and a second track positioned at a second side of the structural opening, and wherein the buoyant volume includes a first spool configured to travel along the first track and a second spool configured to travel along the second track to maintain a generally horizontal orientation of the buoyant volume.

9. The passive flood barrier device of claim 1, wherein the buoyant volume includes a buoyant drum having an axis, wherein the flexible flood barrier is configured to be wrapped around the axis of the buoyant drum.

10. The passive flood barrier device of claim 9, further comprising a retraction mechanism configured to induce rotation of the buoyant drum as it lowers to facilitate wrapping the flexible flood barrier around the buoyant drum.

11. The passive flood barrier device of claim 10, wherein the retraction mechanism comprises a rack and pinion system including a pinion gear coupled to the flexible flood barrier, and a rack gear disposed near a side frame of the structural opening.

12. The passive flood barrier device of claim 10, wherein the retraction mechanism comprises a counterweight coupled to the buoyant drum to oppose a weight of the flexible flood barrier.

13. The passive flood barrier device of claim 9, further comprising:
a guide extending in a vertical direction across at least a portion of the structural opening, the guide operably coupled with the buoyant drum to guide travel of the buoyant drum in the vertical direction to position the flexible flood barrier to form a seal against the structural opening,
wherein the guide includes a track and wherein the buoyant volume includes a spool configured to travel along the track of the guide.

14. The passive flood barrier device of claim 13, wherein the track includes a rack having a plurality of rack teeth and wherein the spool includes a plurality of gear teeth, wherein vertical travel of the spool along the track imparts rotational motion to the buoyant volume via engagement of the rack teeth with the gear teeth.

15. The passive flood barrier device of claim 10, wherein the retraction mechanism includes a spring mechanism configured to induce rotation of the buoyant drum about the axis to re-roll the flexible flood barrier in response to a receding flood water.

16. The passive flood barrier device of claim 1, wherein the buoyant volume includes a flexible flood barrier carrier configured to receive the flexible flood barrier therein.

17. The passive flood barrier device of claim 16, wherein the flexible flood barrier carrier includes a flood barrier track to guide travel of the flexible flood barrier within the flexible flood barrier carrier as the flexible flood barrier is passively retracted into the flexible flood barrier carrier in response to a receding flood water.

18. The passive flood barrier device of claim 1, wherein the flexible flood barrier includes a plurality of stiffening members extending in a horizontal orientation across the flexible flood barrier.

19. The passive flood barrier device of claim 1, wherein the flexible flood barrier includes a plurality of elongate beams, each elongate beam of the plurality of elongate beams pivotally coupled to at least one adjacent elongate beam via a hinge.

20. The passive flood barrier device of claim 19, wherein the flexible flood barrier includes a plurality of gaskets disposed between adjoining edges of the plurality of elongate beams.

21. The passive flood barrier device of claim 1, wherein the flexible flood barrier includes a rubber material to form a water-resistant seal at the structural opening.

22. The passive flood barrier device of claim 1, wherein the flexible flood barrier is configured to resist a wind load, a hydrostatic load, a hydrodynamic load, a wave load, and a debris impact load.

23. The passive flood barrier device of claim 1, wherein the structural opening includes one or more of a wall opening, a tunnel, and/or a building opening including a wall opening, a floor opening, a vent shaft, a door, a window, and/or a louver.

24. The passive flood barrier device of claim 1, wherein a portion of the structural opening is positioned above a ground level and wherein the passive flood barrier device is positioned below the ground level.

25. The passive flood barrier device of claim 1, wherein the flexible flood barrier is partially deployable to maintain an airflow through the structural opening.

26. The passive flood barrier device of claim 1, wherein the flexible flood barrier is supported by structural grating when at least partially deployed.

27. A passive flood barrier device for a structural opening, the passive flood barrier device comprising:
a buoyant drum rotatably disposed across the structural opening in a generally horizontal orientation;
a guide disposed adjacent the structural opening, the guide comprising a pair of tracks configured to guide the buoyant drum upward along the structural opening in response to a rising flood water, and
a flexible flood barrier coupled to the buoyant drum, the flexible flood barrier configured to roll off of the buoyant drum as the buoyant drum travels upward with respect to the guide, the buoyant drum being configured to float to a level corresponding to a level of flood water at the structural opening.

28. The passive flood barrier device of claim 27, wherein the flexible flood barrier is configured to be passively retracted as the buoyant drum travels downward along the guide in response to a receding flood water.

29. The passive flood barrier device of claim 28, wherein passive retraction of the flexible flood barrier is assisted by a retraction mechanism.

30. The passive flood barrier device of claim 27, wherein the buoyant drum has an axis, wherein the flexible flood barrier is configured to be wrapped around the axis of the buoyant drum.

31. The passive flood barrier device of claim 30, further comprising a retraction mechanism that induces rotation of the buoyant drum as it lowers to facilitate re-wrapping the flexible flood barrier around the buoyant drum.

32. The passive flood barrier device of claim 31, wherein the retraction mechanism comprises a rack and pinion system including a pinion gear coupled to the flexible flood barrier, and a rack gear disposed near a side frame of the structural opening.

33. The passive flood barrier device of claim 31, wherein the retraction mechanism comprises a counterweight coupled to the buoyant drum to oppose a weight of the flexible flood barrier.

34. The passive flood barrier device of claim 31, wherein the retraction mechanism includes a spring mechanism configured to induce rotation of the buoyant drum about the axis to re-roll the flexible flood barrier in response to a receding flood water.

35. The passive flood barrier device of claim 27, wherein the flexible flood barrier includes a plurality of elongate beams, each elongate beam of the plurality of elongate beams pivotally coupled to at least one adjacent elongate beam via a hinge.

36. The passive flood barrier device of claim 35, wherein the flexible flood barrier includes a plurality of gaskets disposed between adjoining edges of the plurality of elongate beams.

37. The passive flood barrier device of claim 27, wherein the flexible flood barrier includes a rubber material to form a water-resistant seal at the structural opening.

38. A passive flood barrier device for a structural opening, the passive flood barrier device comprising:
a buoyant volume disposed near the structural opening, the buoyant volume configured to float in response to flood water near the structural opening;
a flexible flood barrier carrier coupled to the buoyant volume; and
a flexible flood barrier configured to be deployed from the flexible flood barrier carrier as the buoyant volume travels upward in response to rising flood water near the structural opening.

39. The passive flood barrier device of claim 38, wherein the flexible flood barrier carrier is configured to receive the flexible flood barrier therein, the flexible flood barrier carrier including a flood barrier track to guide travel of the flexible flood barrier into the flexible flood barrier carrier as the flexible flood barrier is passively retracted into the flexible flood barrier carrier in response to a receding flood water.

40. The passive flood barrier device of claim 39, wherein the flexible flood barrier includes:
a plurality of elongate beams, each elongate beam of the plurality of elongate beams pivotally coupled to at least one adjacent elongate beam via a hinge.

41. The passive flood barrier device of claim 40, wherein the flexible flood barrier includes:
a plurality of gaskets disposed between adjoining edges of the plurality of elongate beams.

42. The passive flood barrier device of claim 40, wherein the flexible flood barrier includes a plurality of rollers coupled to the plurality of elongate beams to facilitate deploying and retracting the flexible flood barrier from and to the buoyant volume.

43. The passive flood barrier device of claim 42, wherein at least one roller of the plurality of rollers is disposed at either lateral end of at least one of the plurality of elongate beams to facilitate deploying and retracting the flexible flood barrier from and to the flexible flood barrier carrier.
